(19) United States
(12) Patent Application Publication
(10) Pub. No.: US 2009/0068495 A1
(43) Pub. Date: Mar. 12, 2009

(54) Methods and Systems for Re-Metallizing Weld Area in Steel Electrical Conduit

(76) Inventors: Thaddeus J. Dembowski, North Olmsted, OH (US); Christopher F. Hinte, Twinsburg, OH (US); Eduardo Gonzalez, Avon Lake, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/851,075

(22) Filed: Sep. 6, 2007

(51) Int. Cl. B23K 9/02; C23C 4/08; B32B 15/01

(52) U.S. Cl. 428/684; 427/455; 427/456; 427/142; 219/59.1; 219/60 R; 219/61.2

(57) ABSTRACT

The present embodiments disclose methods and systems for repairing, reconditioning, and/or re-metallizing the weld seam in steel electrical conduit such that the conduit meets UL standards, as well as other applicable industry and government standards Conduit prepared according to the present embodiments is also disclosed.

### BACKGROUND

Steel electrical conduit products, such as electrical rigid metal conduit (“RMC”), electrical intermediate conduit (“IMC”), and electrical metallic tubing (“EMT”), are used for electrical wiring in residential, commercial, and industrial capacities. They are raceway systems of circular cross-section designed for the physical protection and routing of electrical conductors and cables. They are also used as an equipment-grounding conductor of these three types of conduit. Steel RMC is the heaviest weight and thickest wall steel conduit, having a wall thickness of about 0.104 inches for ½ inch trade size conduit and increasing to about 0.266 inches for 6 inch trade size conduit IMC has a reduced wall thickness and weighs about one-third less than RMC, having a wall thickness of about 0.078 inches for ½ inch trade size conduit and increasing to about 0.150 inches for 4 inch trade size conduit EMT, also known as “thin-wall,” is the thinnest of these three types of conduit, having a wall thickness of about 0.042 inches for ½ inch trade size conduit and increasing to about 0.083 inches for 4 inch trade size conduit.

RMC, IMC, and EMT are subject to rigorous quality standards set by, among others, Underwriters' Laboratories (“UL”), the National Electrical Manufacturers Association (“NEMA”), the American National Standards Institute (“ANSI”), and the National Fire Protection Association (“NFPA”) in the United States, as well as analogous standards in other countries, such as, for example, those set by the Canadian Standards Association (“CSA”). For example, RMC is presently subject to the Standard for Electrical Rigid Metal Conduit—Steel, UL 6 and ANSI C80.1, and National Electric Code (“NEC”) Article 344. IMC is subject to the Standard for Electrical Intermediate Metal Conduit—Steel, UL 1242 and ANSI C80.6, and NEC Article 342. EMT is subject to the Standard for Electrical Metallic Tubing—Steel, UL 797 and ANSI C80.3, and NEC Article 358.

UL 6, UL 797, and UL 1242 have historically specified zinc as a primary coating for corrosion protection of electrical conduit. ANSI steel conduit standards C80.1, C80.3, and C80.6 have similar standards for these products that also require a coating of zinc. Zinc coating of steel products enables steel, one of the most recyclable materials, to be used in applications where steel might not otherwise be acceptable Zinc corrodes much more slowly than steel and possesses sacrificial galvanic properties when attached to steel. In other words, oxygen will attack the zinc rather than the steel. Aluminum, zinc/aluminum alloys, tin and its alloys with zinc and aluminum, and other metallic coatings may also have suitable corrosion protection properties. Exemplary corrosion properties of various materials are set forth in the ASM Handbook of Corrosion Data, 2^{nd} Ed, which is incorporated herein by reference.

Current methods of manufacturing RMC, IMC, and EMT include slitting uncoated (i.e., unmetallized) steel coils, forming and welding the slit coils into a tube, and applying zinc onto the surface of the tube by one of three processes: (1) hot-dipping the tube into a bath of molten zinc; (2) flow coating; and (3) electro-galvanizing. Due to the nature of these processes and the peculiarities of steel conduit, the zinc coating thickness and adhesion to the steel tube are difficult to control. As a result, the conduit produced by these processes may not consistently pass the requirements of UL, ANSI, and NEMA, among others

Attempts have also been made to produce steel conduit by forming pre-galvanized steel coil (that is, steel coil that has been protected from corrosion by a specified coating of zinc) into tubular form and welding the abutting edges together to form a tube. However, the heat necessary to weld the edges together exceeds the melting point (419.53° C./787.15° F.) and boiling point (907° C./1665° F.) of the zinc coating, causing the coating to melt, volatilize, evaporate, or otherwise be compromised or destroyed, at and around the weld seam. The coating around the strip edges can be further damaged upon forming and processing in the mill. Adequately re-metallizing the weld seam with zinc has proven up to this point to be “impossible.” U.S. Pat. No. 3,827,139; U.S. Pat. No. 4,082,212; U.S. Pat. No. 4,191,319. Left untreated (i.e., un-metallized), the bare steel at and around the weld seam is exposed and will corrode at a much greater rate. Unprotected, the steel conduit will corrode such that, for example, enclosed electrical wires may be exposed, creating the possibility of an electrical fire or electrocution. Left unprotected, the steel conduit will also not meet the various industry and government standards to which it is subject.

Similarly, in forming aluminized tubing from coated aluminum coil, the heat generated in the welding process may exceed the melting point (660.32° C./1220.58° F.) and, although less likely, the boiling point (2519° C./4566° F.) of the aluminum coating, causing the coating to be compromised at and around the weld seam.

The present embodiments disclose methods and systems for reconditioning, repairing, and/or re-metallizing the weld area, the weld zone, and/or the heat affected zone or area in steel electrical conduit such that the conduit may meet UL, ANSI, NEMA, CSA, and other applicable standards. Conduit prepared according to the present embodiments is also disclosed.

### SUMMARY

In one embodiment, a method for re-metallizing zinc-coated steel conduit in a single spray metallization stage is provided, the method comprising: forming a zinc-coated steel strip into an open seamed tube, bringing two of the strip's edges into abutting relation; welding the two abutting edges together at a weld point, creating a weld area in which the zinc coating is compromised, the weld area having a temperature; placing a thermal sprayer over the weld area, capable of spraying molten metal over at least a portion of the weld area; changing the temperature of the weld area to a temperature at or below the melting point of the molten metal prior to spraying the molten metal over the weld area; and spraying the molten metal over at least a portion of the weld area, forming an adherent bond between the weld area and the molten metal.

In another embodiment, a method for repairing a weld seam on coated steel tubing is provided, the method comprising: forming a coated steel strip into tubular shape, bringing two edges of the strip into intimate contact with each other; welding the two edges together at a weld point, creating a weld zone; placing a first spraying device over the weld zone, the first spraying device being configured to spray molten zinc; and spraying molten zinc from the first spraying device on at least a portion of the weld zone, wherein the weld zone has a temperature after being contacted by the molten zinc that is below the boiling point of zinc. The method may further comprise placing a second spraying device over the weld zone, the second spraying device being configured to spray molten metal; and spraying molten metal from the second spraying device on at least a portion of the weld zone.

In another embodiment, welded steel conduit is provided, the welded steel conduit having: a first coating of zinc, and having a weld area; the weld area having an outer surface; the first coating of zinc being in contact with the steel conduit other than over the outer surface of the weld area; and a second zinc coating disposed over the outer surface of the weld area, the second coating being sufficiently thick and sufficiently adhered to the steel conduit at the weld area to withstand at least four one-minute submersions in a copper sulfate solution having a specific gravity of about 1.186 at a temperature of from about 63-67° F.

In yet another embodiment, welded steel conduit is provided, the welded steel conduit having: a coating of zinc, and having a weld area; the weld area having an outer surface; the coating of zinc being in contact with the steel conduit other than over the outer surface of the weld area; and an aluminum coating disposed over the outer surface of the weld area, the aluminum coating being sufficiently thick and sufficiently adhered to the steel conduit at the weld area to withstand the alternative corrosion resistance tests described by UL 6.2.4, which is incorporated herein by reference.

In still another embodiment, welded steel conduit is provided, the welded steel conduit having: a coating of zinc, and having a weld area; the weld area having an outer surface; the coating of zinc being in contact with the steel conduit other than over the outer surface of the weld area; and a zinc/aluminum alloy coating disposed over the outer surface of the weld area, the zinc/aluminum alloy coating being sufficiently thick and sufficiently adhered to the steel conduit at the weld area to withstand the alternative corrosion resistance tests described by UL 6.2.4.

In another embodiment, a system is provided for re-metallizing a heat affected zone on zinc coated steel conduit, the system comprising: an advancer, configured to move a zinc coated steel strip along a path of travel; a tube former, configured to form the steel strip into a tubular shape with two edges of the steel strip being in abutting relation; a welder, capable of welding the two abutting edges together at a weld point, the welding causing at least a portion of the zinc coating to be depleted, creating the heat affected zone; and a first spray metallizer, capable of spraying molten zinc onto at least a portion of the heat affected zone, wherein the molten zinc sprayed onto the heat affected zone is sufficiently thick and sufficiently adhered to the heat affected zone to withstand at least four one-minute submersions in a copper sulfate solution having a specific gravity of about 1.186 at a temperature of from about 63-67° F.

### BRIEF DESCRIPTION OF THE DRAWINGS

The accompanying figures, which are incorporated in and constitute a part of the specification, illustrate various example systems, methods, results and so on, and are used merely to illustrate various exemplary embodiments.

FIG. 1 is a flow diagram illustrating an example method 100 for re-metallizing a weld seam on coated steel conduit in a single stage.

FIG. 2 illustrates an exemplary embodiment of a system 200 for re-metallizing a weld seam on coated steel conduit in a single stage.

FIG. 3 is a flow diagram illustrating an example method 300 for re-metallizing a weld seam on coated steel conduit in two or more stages.

FIG. 4 illustrates a representative piece of welded steel conduit, the welded steel conduit having: a coating of zinc, and having a weld area; the weld area having an outer surface; the coating of zinc being in contact with the steel conduit other than over the outer surface of the weld area; and a second metal coating disposed over the outer surface of the weld area, and being in contact with the steel conduit.

### DETAILED DESCRIPTION

When used herein, the term “about” means ±10% of the stated value. For example, “about” 10 may mean from 9 to 11.

When used herein, the term “consisting essentially of” may mean, when applied to a particular metal, the metal itself, along with other trace (i.e., less than or equal to about 0.5% by weight) metals or other substances. By way of illustration only, if an embodiment recites “consisting essentially of zinc,” the zinc may additionally include trace amounts of lead, cadmium, tin, iron, copper, and other substances.

In one embodiment, a method for re-metallizing zinc-coated steel conduit in a single spray metallization stage is provided, the method comprising: forming a zinc-coated steel strip into an open seamed tube, bringing two of the strip's edges into abutting relation; welding the two abutting edges together at a weld point, creating a weld area in which the zinc coating is compromised, the weld area having a temperature; placing a thermal sprayer over the weld area, capable of spraying molten metal over at least a portion of the weld area; changing the temperature of the weld area to a temperature at or below the melting point of the molten metal prior to spraying the molten metal over the weld area; and spraying the molten metal over at least a portion of the weld area, forming an adherent bond between the weld area and the molten metal.

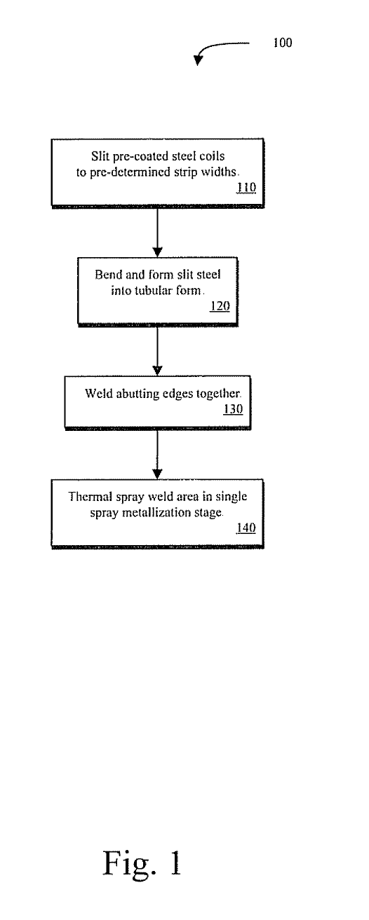

FIG. 1 is a flow diagram illustrating an example method 100 for re-metallizing a weld seam on coated steel conduit in a single stage. Method 100 may include, at 110, slitting a master steel coil to form strips of a particular width corresponding approximately to the outside circumference of the intended tube size. The master coil itself may be pre-galvanized steel or any pre-coated steel, including, without limitation: commercial steel, forming steel, deep drawing steel, extra deep drawing steel, hot-rolled steel, cold-rolled steel, and the like. The master coil may be hot dip galvanized, electrogalvanized, hot dipped galvannealed, aluminized, UV coated, or hybrid coated. The master coil may further be acrylic coated, painted, or both. The master coil may be cold-worked to improve its physical attributes and properties. The strips or slit coil may be formed into an open seamed tube (120), such that two of the strip's edges are brought into abutting relation The two abutting edges may be welded together (130), creating a heat affected zone in which the zinc coating is damaged or otherwise compromised. Suitable welding techniques include, for example, continuous welding processes, including, without limitation, electrical resistance welding (e.g., high frequency and low frequency welding), laser welding, and TIG welding. Finally, the weld area may be spray metallized in a single spray metallization stage, as shown at 140.

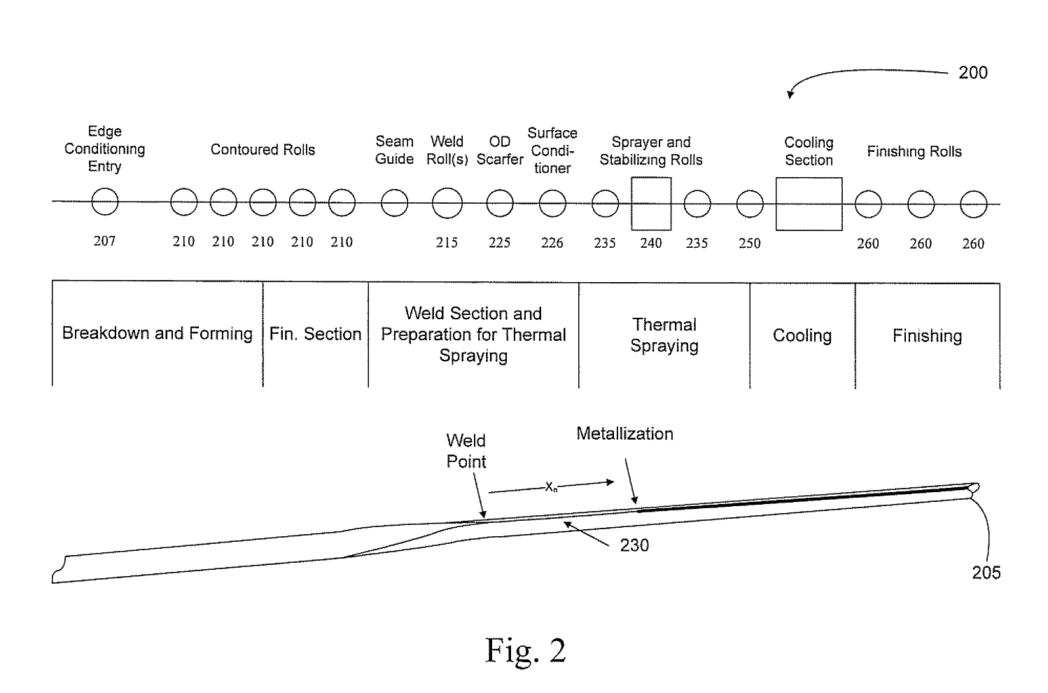

FIG. 2 illustrates an exemplary embodiment of a system 200 for re-metallizing a weld seam on coated steel conduit in a single stage. Pre-galvanized steel coil may be cut or slit into pre-determined strips. A strip may be fed into a tube mill and formed into tubular shape, bringing the strip's edges into abutting relation The strip is typically centered and aligned upon entry into the tube mill A seam guide may or may not be necessary, depending on the integrity of the tube mill. The strip edges typically have no further conditioning performed on them, until the fin section of the mill. However, the strip edges and/or the strip surfaces adjacent to the edges may be conditioned by, for example, skiving, strip shaving, rolling, coining at 207, or edge conditioning at the fin section. The strip, which may become EMT, IMC, or RMC, passes through contoured rolls 210, which form and prepare the abutting edges of the tube for the subsequent welding operation Downstream of contoured rolls 210 may be welder 215. Welder 215 may weld the two abutting edges of tube 205 together at a weld point. The welded tube 205 may emerge from the welder 215 with an outside flash at the weld seam. The outside flash may be removed with, for example, one or more scarfing tools 225. Alternatively, the outside flash may be rolled back into and blended with the outer diameter of the conduit. The weld seam may be further conditioned with a rotary brush or other surface conditioning tool 226 and/or process as known in the art.

Tubing 205 may have a “weld zone” or “weld area” 230 from which the original zinc coating may have been melted off, volatilized, or otherwise compromised during the welding and conditioning steps. Weld zone 230 may be an area on steel tube 205 of significantly or completely depleted zinc. In other words, a narrow area of exposed or partially exposed steel may exist along and around the weld seam.

Downstream from scarfing tool 225 may be one or more entry stabilizing rolls 235. Also positioned downstream may be a moveably mounted thermal sprayer 240, configured to spray molten metal on the weld zone. Sprayer 240 may be, for example, electric arc spray, flame spray, plasma arc spray, cold spray, HVOF, or other splay inputs. Sprayer 240 may be configured to spray molten metal comprising or consisting essentially of zinc, aluminum, alloys of zinc and aluminum, including a zinc/aluminum alloy having a ratio of about 85/15, tin, alloys of tin and zinc, alloys of tin and aluminum, or any other metal or metal alloy capable of effectively adhering to the weld seam and having sufficient corrosion protection properties The sprayer may be configured to spray molten metal from metal powders, a single metal wire, a single metal alloy wire, cored wire, or multiple wires, multiple wires of different material The wires may be of the same or different diameter. Suitable wires may include, for example, Praxair/Tafa thermal spray wires, such as 02Z Zinc wire, which melts at 788° F., 02A zinc/aluminum wire 85/15, which melts at 824° F., 01T aluminum wire, which melts at 1215° F., 02W tin wire, which melts at 450° F., and 02T zinc/tin wire 80/20, which melts at 518° F.

As stated above, the heat generated by welder 215 may be so high as to boil off or volatilize at least a portion of the original zinc coating. As such, sprayer 240 will be placed at a sufficient longitudinal distance (i.e., the distance downstream) from the weld point to avoid volatilizing the molten metal applied via sprayer 240. Sprayer 240 will also be placed at a sufficient vertical distance from weld area 230. For example, the longitudinal distance of thermal sprayer 240 from welder 215 is theoretically limitless. In some applications, the longitudinal distance may be from about 10″ to about 30 feet, but may readily be shortened or lengthened by those skilled in the art. The standoff distance (i.e., the distance between the thermal sprayer and the portion of the weld area to be sprayed when the thermal sprayer is positioned over the portion of the weld area to be sprayed) may be from about ⅛″ to about 10″, although appropriate processing configurations and adaptations may expand this range as well. Thermal sprayer 240 is also adjustable transversely and angularly, by any means. As set forth above, stabilizing rolls 235 and similar stabilizing equipment may be placed on one or both sides of the metallization position to keep the conduit stable. There typically is no significant relative movement between sprayer 240 and the surface of the tube, other than the longitudinal movement of the tube along the path of the tube mill.

The inside diameter surface may likewise have an area of depleted zinc coating after welding This surface may have to be repaired, reconditioned, and/or re-metallized in order to pass applicable government and industry standards. The inside diameter surface area may be repaired, reconditioned, and/or re-metallized according to conventional means The inside diameter surface processing may be performed, for example, “in-line” on a tube mill, or in an off-line cell. The inside diameter may be repaired using an organic or zinc material, paint, or any appropriate product that will meet the applicable government and industry standards for EMT, IMC, and RMC conduit. For example, the material sprayed onto the heat affected zone on the inside diameter may be sufficiently thick and sufficiently adhered to the inner heat affected zone to withstand at least one one-minute submersion in a copper sulfate solution having a specific gravity of about 1.186 at a temperature of from about 63-67° F.

The position of sprayer 240 may be determined, at least in part, by the temperature of weld zone 230 as it approaches sprayer 240. The temperature of the substrate may be measured using thermal imaging or a pyrometer, such as an IR two color The temperature of the substrate may be adjusted or changed by adjusting the longitudinal position, input spray parameters, particle heating and velocity, substrate condition, mill speed, flood cooling, air jets, chillers, heat exchangers, welding input, slit strip burr orientation, slit strip width, and the like. For example, in one embodiment, the temperature of the weld zone at the point of contact with the sprayed metal may be adjusted by increasing or decreasing the mill speed, the longitudinal distance, or both It should be noted, however, that “changing” the temperature of the substrate prior to thermally spraying does not necessarily require an affirmative act. In other words, the temperature of the substrate may be “changed” simply by allowing the substrate to air cool between the weld point and the thermal sprayer, without adjusting the mill speed, longitudinal distance, or any other processing parameter

Acceptable adherence between the base metal and the thermally sprayed metal has been achieved, for example, where the temperature of the thermally sprayed metal is at or above the melting point of the thermally sprayed metal but below its boiling point; and where the temperature of the base metal at the weld area just before spraying is low enough (typically below the melting point of the thermally sprayed metal) that when the base metal is sprayed with the thermally sprayed metal, the temperature of the portion of the base metal being sprayed may be increased, but remains below the boiling point of the thermally sprayed metal, thereby forming an adherent metallurgical, mechanical, chemical, physical, or other such bond between the thermally sprayed metal and the base metal. The combined temperatures typically are low enough so that the thermally sprayed metal freezes quickly enough to enable sufficient depth of the coating in order to pass the various industry standards.

Sprayer 240 may spray molten metal onto weld zone 230 such that weld zone 230 has a sufficiently thick, adherent coating of metal so as to pass the applicable industry and government standards. Tube 205 may be further stabilized by stabilizing rolls 235, and, optionally, the re-metallized weld seam may be further conditioned by ironing pass 250.

Further metallic or non-metallic exterior coating(s) may also be applied, for example, to retard white rust or to increase corrosion protection. In addition, an ironing stand, sizing rolls, Turk's Head, straightening stand, and cold working stands may be utilized on the tube mill to improve surface conditions, shape, straightness, and durability. It will be evident to the person of ordinary skill in the art that depending on the integrity of the tube mill upon which the present embodiments are carried out, depending on the desired cosmetic appearance of the tubing, and depending on the type and size of the tubing being processed, more or fewer stabilizing rolls, scarfing and/or other surface conditioning devices, and working rolls may be desirable. Additional cold working may also be advantageous, and may be accomplished by an ironing pass, changed radius design on working rolls, specialized tools or rolls, or additional stations The cold work may include plastic deformation carried out in a temperature region and time interval dependent upon mill speed. The cold work may be performed where the temperature of the welded and coated conduit is from ambient temperature to about 392° F. The cold work may be completed in a single pass or a combination of passes with various rolls, such as at 250 and/or 260, and tools commonly known in the art.

As illustrated, sprayer 240 is typically positioned downstream from scarfing tools 225. Those of ordinary skill, however, will recognize exceptions to such a configuration which are consistent with the present embodiments. For example, in one alternate embodiment, a tube mill may be configured without scarfing tools 225. In such an embodiment, sprayer 240 would be positioned to spray over the unscarfed weld seam of tubing 205. In another alternate embodiment, the weld seam may be conditioned and could be rolled or cold worked, reheated, and sprayed farther downstream.

In another embodiment, a method for repairing a weld seam on coated steel tubing is provided, the method comprising: forming a coated steel strip into tubular shape, bringing two edges of the strip into intimate contact with each other; welding the two edges together at a weld point, creating a weld zone; placing a first spraying device over the weld zone, the first spraying device being configured to spray molten zinc; and spraying molten zinc from the first spraying device on at least a portion of the weld zone, wherein the weld zone has a temperature after being contacted by the molten zinc that is at or above the melting point of zinc but below the boiling point of zinc. The method may further comprise placing a second spraying device over the weld zone, the second spraying device being configured to spray molten metal; and spraying molten metal from the second spraying device on at least a portion of the weld zone.

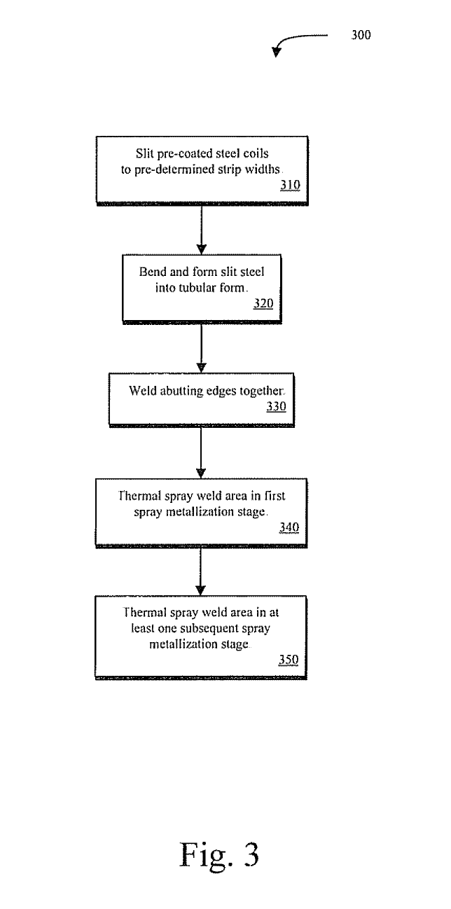

FIG. 3 is a flow diagram illustrating an example method 300 for re-metallizing a weld seam on coated steel conduit in two or more stages. Method 300 may include, at 310, slitting steel coils to a width approximately corresponding to the circumference of the tube size. The coil may be formed into tubular form (320), such that two of the edges are brought into abutting relation. The abutting edges may be welded together (330), creating a weld area in which the zinc coating is volatilized. The weld area may then be spray metallized in a first spray metallization stage using zinc, as described at 340. The weld area may be further spray metallized, as described at 350, using a second spray metallizer capable of coating the weld seam with molten zinc, aluminum, zinc/aluminum alloy, tin and its zinc and aluminum alloys, or any other known coating having similar beneficial properties, as described herein. It will be instantly clear to the person of ordinary skill that any number of spray metallizing stages greater than two may also be used in conjunction with the present embodiments.

In another embodiment, a system is provided for re-metallizing a heat affected zone on zinc coated steel conduit, the system comprising: an advancer, configured to move a zinc coated steel strip along a path of travel; a tube former, configured to form the steel strip into a tubular shape with two edges of the steel strip being in abutting relation; a welder, capable of welding the two abutting edges together at a weld point, the welding causing at least a portion of the zinc coating to be depleted, creating the heat affected zone; and a first spray metallizer, capable of spraying molten zinc onto at least a portion of the heat affected zone, wherein the molten zinc sprayed onto the heat affected zone is sufficiently thick and sufficiently adherent to the heat affected zone to withstand at least four one-minute submersions in a copper sulfate solution having a specific gravity of about 1.186 at a temperature of from about 63-67° F.

The system may further comprise a temperature adjuster. The system may also further comprise a second spray metallizer, capable of spraying a molten metal onto the weld seam. The molten metal may be, for example, zinc, aluminum, tin, or an alloy of zinc and aluminum, zinc and tin, or tin and aluminum. The first spray metallizer may be an electric arc spray gun. The tube former may be a tube mill. The welder may be continuous welder, such as, for example, an electric resistance welder, a TIG welder, or a laser welder. The system may take a form, for example, similar to that displayed or described in FIGS. 1, 2, or 3.

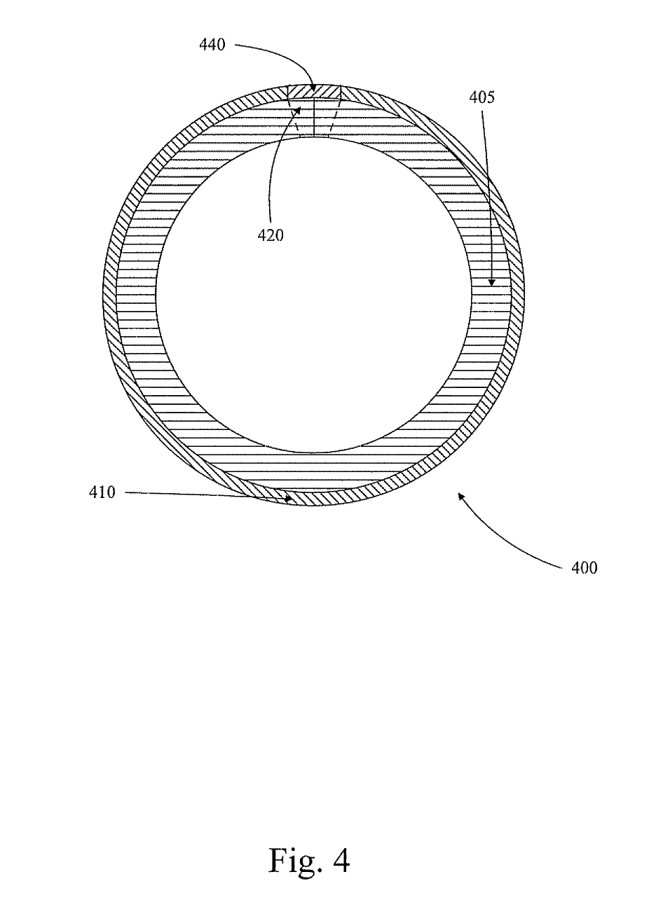

Several different combinations of steel conduit may be prepared in accordance with the present embodiments. For example, with reference to FIG. 4, welded steel conduit 400 may be produced in accordance with the present embodiments, the welded steel conduit 400 having: a steel substrate 405; a first coating 410, having a weld area 420; the first coating 410 being in contact with the steel substrate 405 other than over the weld area 420; and a second coating 440 disposed over the weld area 420, the second coating 440 being sufficiently thick and sufficiently adhered to the steel substrate 405 at the weld area 420 to withstand at least four one-minute submersions in a copper sulfate solution having a specific gravity of about 1.186 at a temperature of about 65° F.±2° F. The first coating 410 and the second coating 440 may be the same or they may be different. The first coating 410 and the second coating 440 (and any subsequent coatings over the first or second coatings) may comprise or consist essentially of, for example, zinc, aluminum, zinc/aluminum alloy, tin, zinc/tin alloy, aluminum/tin alloy, or any other appropriate metallic coating as described herein. In another embodiment, the steel conduit 400 may have one or more additional coatings over the first, second, or subsequent metal coatings, including, without limitation, organics, inorganics, vinyls, resins, waxes, chromates, phenols, epoxides, polyurethanes, plastisols, acrylics, epoxies, lacquers, polyesters, silicones, paint, and the like The person of ordinary skill in the art will readily recognize that conduit 400 will also have an inner diameter, which may have a weld area, one or more metallic coatings, and the like (not shown).

One of ordinary skill will recognize that the example systems of FIGS. 1, 2, or 3 may include optional elements not shown or described, but which are consistent with the present embodiments. For example, in one alternate embodiment, system 200 may include a heating element or a cooling apparatus or other temperature adjuster positioned before or after sprayer 240. The heating element, for example, may be operative to heat the tubing 205 after the molten metal is applied. In certain environments, the additional heating may improve the bond between the thermally sprayed metal and the substrate, as well as the anti-corrosive properties.

In another alternate embodiment, system 200 may include a conditioning (e.g., roughening or smoothing) element configured to condition the substrate of tubing 205 prior to application of the molten metal by sprayer 240. The conditioned substrate may likewise improve the bond between the coating metal and the substrate.

For convenience, the embodiments disclosed herein have been shown in the context of a tube mill or other similar apparatus. However, it will be readily apparent to those skilled in the art that the present embodiments are equally well implemented “off-line” of a tube mill or similar apparatus or system.

### EXAMPLES

### Example 1

A pre-galvanized master coil was slit into multiple widths of 4.700″ wide. The slit steel was fed into a Yoder M 2.500 tube mill, welded, and thermal sprayed at a mill speed of 160 feet per minute to produce 1¼″ EMT. The run included an Ircon Modline 5 pyrometer, a weld power source comprising a 150 KW Thermatool solid state induction welder, and a thermal spray unit comprising a Praxair/Tafa BP400 electric arc spray gun.

The conduit was welded and cosmetically adjusted as described herein. The BP400 electric arc spray gun was mounted and positioned 44 inches downstream of the weld point, at a stand off distance of about ¾″ from the weld zone. The manufacturing process parameters included an electromotive force of 22.7 volts, a current of 164 amps, and an air pressure of 90 psi, using 1/16″ zinc wire (Praxair 02Z—Lot No. W184927). The temperature of the weld zone was measured using the Ircon Modline 5 pyrometer. The temperature of the base metal at the point of contact just prior to contact with the thermally sprayed metal (Temp M) was 490° F.

After cooling, the conduit was visually inspected and was found to have a smooth texture at the re-metallized area, and was found to have a consistent appearance with the intact portions of the conduit. The tubing was also subjected to the standard copper sulfate test (the “Preece test”), as defined in UL 797 Eighth Ed., section 6.2.2, which is incorporated herein by reference, and withstood at least four one-minute submersions in copper sulfate solution without any bright, adherent deposit of copper onto the outer surface of the conduit.

Examples 2-7 set forth in tabular format the parameters and results obtained according to the present exemplary embodiments.

EXAMPLES 2-7

| | | Long | | Mill | | | | | | |
|---|---|---|---|---|---|---|---|---|---|---|
| | Thermal | Dis | S O | Speed | Amps | Volts | Wire | Air | Temp M | Dips |
| Example # | Sprayer | In. | In. | fpm | a | v | type | psi | f | # |
| 2 | BP400 | 44 | 2 | 80 | 210 | 22 | Zn | 85 | 534 | 4 |
| 3 | BP400 | 44 | 2 | 128 | 210 | 21.8 | Zn | 85 | 515 | 3 |
| 4 | BP400 | 44 | ¾ | 128 | 225 | 21.8 | Zn | 90 | 515 | 4 |
| 5 | BP400 | 44 | ¾ | 128 | 225 | 22.1 | Zn | 90 | 515 | 4 |
| 6 | BP400 | 44 | ¾ | 160 | 225 | 22.1 | Zn | 90 | 490 | 4 |
| 7 | BP400 | 44 | ¾ | 160 | 121 | 23.3 | Zn | 90 | 490 | 3 |

Changing the mill speed may have a direct result on successfully passing the corrosion resistant test. With no other adjustments, the mill speed in Example 3 was increased by 48 fpm over Example 2, which resulted in Example 3 passing only 3 dips of the UL corrosion resistant test In Example 4, adjustments were made to the standoff distance, amps, and air pressure, while the mill speed remained the same as Example 3. These adjustments resulted in Example 4 passing 4 dips. Similarly, changing the amps may have a direct result on successfully passing the corrosion resistant test. For example, Example 7 failed the corrosion resistant test when the amperage was reduced by 104 amps as compared to Example 6. It should be noted that conduit that fails the Preece test, such as the conduit prepared in Example 3, may be subjected to additional cold working by increased roll pressure in the mill's sizing rolls. After cold working, the conduit may pass four or more one-minute submersions in the described copper sulfate solution.

### Example 8

A pre-galvanized master coil was slit into multiple widths of 5.470″ wide. The slit steel was fed into a Yoder M 2.500 tube mill, welded, and thermal sprayed at a mill speed of 107 feet per minute to produce 1½″ EMT. The run included an Icron Modline 5 pyrometer, a weld power source comprising a 150 KW Thermatool solid state induction welder, and a thermal spray unit comprising a Praxair/Tafa Model 8835 electric arc spray

The conduit was welded and cosmetically adjusted using a single scarfing tool, no rotary brush, and no stabilizing rolls. The Model 8835 electric arc spray gun was mounted and positioned about 47¼ inches downstream of the weld point, at a stand off distance of about 1 inch from the weld zone. The manufacturing process parameters included an electromotive force of 25 volts, a current of 180 amps, and an air pressure of 70 psi, using 1/16″ zinc wire (Praxair 02Z—Lot No. W184927). The temperature of the weld zone was measured using the Icron Modline 5 pyrometer. The temperature of the base metal at the point of contact just prior to contact with the thermally sprayed metal (Temp M) was 715° F.

After cooling, the conduit was visually inspected and was found to have a smooth texture at the re-metallized area, and was found to have a consistent appearance with the intact portions of the conduit. The tubing was also subjected to the Preece test, and withstood at least 4 one-minute submersions in copper sulfate solution without any bright, adherent deposit of copper onto the outer surface of the conduit.

Examples 9-16 set forth in tabular format the parameters and results obtained according to the present exemplary embodiments.

EXAMPLES 9-16

| | | Long | | Mill | | | | | | |
|---|---|---|---|---|---|---|---|---|---|---|
| | | Dis | S O | Speed | Amps | Volts | Wire | Air | Temp M | Dips |
| Example # | Gun Type & H | in. | In. | fpm | a | v | type | psi | f | # |
| 9 | 8835 | 47¼ | 1 3/16 | 53 | 100 | 24 | Zn | 62 | 615 | 4 |
| 10 | 8835 | 47¼ | ¾ | 53 | 150 | 24 | Zn | 62 | 615 | 4 |
| 11 | 8835 | 47¼ | 1½ | 53 | 150 | 24 | Zn | 62 | 615 | 4 |
| 12 | 8835 | 47¼ | 1½ | 53 | 150 | 24 | Zn | 62 | 615 | 4 |
| 13 | 8835 | 47¼ | 1½ | 53 | 150 | 24 | Zn | 62 | 615 | 4 |
| 14 | 8835 | 47¼ | 1 | 107 | 180 | 25 | Zn | 70 | 715 | 4 |
| 15 | 8835 | 47¼ | 1 | 107 | 180 | 25 | Zn | 70 | 715 | 4 |
| 16 | 8835 | 47¼ | 1 | 107 | 175 | 26 | Zn | 75 | 715 | 4 |

### Example 17

A pre-aluminized master coil was slit and fed into a Yoder M 2,500 tube mill, welded, and thermal sprayed at a mill speed of 76 feet per minute to produce 1-¾″×047 ″ tubular product. The run included a weld power source comprising a 150 KW Thermatool solid state induction welder and a thermal spray unit comprising a Praxair/Tafa Model 8835 electric arc spray.

The conduit was welded and cosmetically adjusted using a single scarfing tool, no rotary brush, and no stabilizing rolls. The Model 8835 electric arc spray gun was mounted and positioned about 47¼ inches downstream of the weld point, at a stand off distance of about 2¾ inches from the weld zone. The manufacturing process parameters included an electromotive force of 36 volts, a current of 75 amps, and an air pressure of 75 psi, using 1/16″ (Praxair 02T) aluminum wire. The weld seam and the entire tube surface successfully passed 8 dips in a copper sulfate solution, as described herein, without any bright, adherent deposit of copper onto the outer surface of the conduit

It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicants' general inventive concept. Thus, for example, the mill speed may be from about 30 fpm to about 1125 fpm. The standoff distance may be from about ¼″ to 4″. The air pressure may be up to about 150 psi. The voltage may be from about 16 volts to about 40 volts. The spray current may be up to about 350 amperes. A person of ordinary skill will readily recognize that optimizing or manipulating any one of these variables may or will require or make possible the manipulation of one or more of the other of these variables, and that any such optimization or manipulation is within the spirit and scope of the present embodiments.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the testing measurements.

Furthermore, while the systems, methods, and so on have been illustrated by describing examples, and while the examples have been described in considerable detail, it is not the intention of the applicants to restrict, or in any way limit, the scope of the appended claims to such detail. Thus, this application is intended to embrace alterations, modifications, and variations that fall within the scope of the appended claims. The preceding description is not meant to limit the scope of the invention Rather, the scope of the invention is to be determined by the appended claims and their equivalents.

Finally, to the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed 1995).

What is claimed is:

1. A method for re-metallizing zinc-coated steel conduit in a single spray metallization stage, comprising:
forming a zinc-coated steel strip into an open seamed tube, bringing two of the strip's edges into abutting relation;
welding the two abutting edges together at a weld point, creating a weld area in which the zinc coating is compromised, the weld area having a temperature;
placing a thermal sprayer over the weld area, capable of spraying molten metal over at least a portion of the weld area;
changing the temperature of the weld area to a temperature at or below the melting point of the molten metal prior to spraying the molten metal over the weld area; and
spraying the molten metal over at least a portion of the weld area, forming an adherent bond between the weld area and the molten metal

2. The method of claim 1, wherein the changing comprises reducing.

3. The method of claim 1, wherein the changing comprises increasing

4. The method of claim 1, wherein the weld area has a temperature after spraying that is between the boiling point and the melting point of the molten metal.

5. The method of claim 1, wherein the spraying comprises spraying the weld area with a molten metal comprising molten zinc.

6. The method of claim 1, wherein the spraying comprises spraying the weld area with a molten metal comprising molten aluminum.

7. The method of claim 1, wherein the spraying comprises spraying the weld area with a molten metal comprising a molten alloy of zinc and aluminum.

8. The method of claim 1, wherein the spraying comprises spraying the weld area with a molten metal comprising a molten alloy of zinc and aluminum having a ratio of about 85% zinc to about 15% aluminum.

9. The method of claim 1, wherein the spraying comprises spraying the weld area with a molten metal comprising tin, an alloy of zinc and tin, or an alloy of tin and aluminum.

10. The method of claim 1, wherein the zinc-coated steel conduit is electrical metallic tubing.

11. The method of claim 1, wherein the zinc-coated steel conduit is electrical rigid metal conduit.

12. The method of claim 1, wherein the zinc-coated steel conduit is electrical intermediate conduit.

13. The method of claim 1, wherein the placing comprises placing the thermal sprayer at a longitudinal position of from at least about 28 inches from the weld point.

14. The method of claim 1, wherein the placing comprises placing the thermal sprayer at a standoff distance of from about ¼ inch to about 4 inches from the weld area.

15. The method of claim 1, further comprising passing the conduit from the weld point under the thermal sprayer in a longitudinal direction.

16. The method of claim 15, the passing comprising passing at a speed of about 30 feet per minute to about 1125 feet per minute.

17. The method of claim 15, the passing comprising passing at a speed of about 40 feet per minute to about 300 feet per minute.

18. The method of claim 1, further comprising applying a spray current of up to about 350 amperes.

19. The method of claim 1, further comprising applying a spray current of from about 50 to about 275 amperes.

20. The method of claim 1, further comprising positioning the thermal sprayer at an angle of from about 45 degrees to about 90 degrees relative to the weld area.

21. The method of claim 1, further comprising positioning the thermal sprayer at a 90 degree angle relative to the weld area.

22. The method of claim 1, wherein the spraying comprises spraying at a pressure of up to about 150 psi.

23. The method of claim 1, wherein the spraying comprises spraying at a pressure of about 50 to about 100 psi.

24. The method of claim 1, further comprising applying an electromotive force of from about 16 to about 40 volts.

25. The method of claim 5 wherein the temperature of the weld area is from about 275° F. to about 900° F. prior to spraying.

26. The method of claim 1, further comprising cold-working the weld area after the weld area has been thermally sprayed.

27. A method for repairing a weld seam on coated steel tubing, comprising:
forming a coated steel strip into tubular shape, bringing two edges of the strip into intimate contact with each other;
welding the two edges together at a weld point, creating a weld zone;
placing a first spraying device over the weld zone, the first spraying device being configured to spray molten zinc; and
spraying molten zinc from the first spraying device on at least a portion of the weld zone,
wherein the weld zone has a temperature after being contacted by the molten zinc that is below the boiling point of zinc.

28. The method of claim 27, further comprising:
placing a second spraying device over the weld zone, the second spraying device being configured to spray molten metal; and
spraying molten metal from the second spraying device on at least a portion of the weld zone.

29. The method of claim 28, wherein the spraying molten metal from the second spraying device comprises spraying zinc.

30. The method of claim 28, wherein the spraying molten metal from the second spraying device comprises spraying aluminum.

31. The method of claim 28, wherein the spraying molten metal from the second spraying device comprises spraying an alloy of zinc and aluminum.

32. The method of claim 28, wherein the spraying molten metal from the second spraying devices comprises spraying tin, an alloy of tin and zinc, or an alloy of tin and aluminum.

33. The method of claim 28, wherein the first spraying device is at a first longitudinal distance from the weld zone and the second spraying device is at a second longitudinal distance from the weld zone.

34. The method of claim 33, wherein the first longitudinal distance and the second longitudinal distance are equal to each other.

35. Welded steel conduit having: a first coating of zinc, and having a weld area; the weld area having an outer surface; the first coating of zinc being in contact with the steel conduit other than over the outer surface of the weld area; and a second zinc coating disposed over the outer surface of the weld area, the second zinc coating being sufficiently thick and sufficiently adhered to the steel conduit at the weld area to withstand at least four one-minute submersions in a copper sulfate solution having a specific gravity of about 1,186 at a temperature of from about 63° F. to about 67° F.

36. A system for re-metallizing a heat affected zone on zinc coated steel conduit, comprising:
an advancer, configured to move a zinc coated steel strip along a path of travel;
a tube former, configured to form the steel strip into a tubular shape with two edges of the steel strip being in abutting relation;
a welder, capable of welding the two abutting edges together at a weld point, the welding causing at least a portion of the zinc coating to be depleted, creating the heat affected zone; and
a first spray metallizer, capable of spraying molten zinc onto at least a portion of the heat affected zone, wherein the molten zinc sprayed onto the heat affected zone is sufficiently thick and sufficiently adhered to the heat affected zone to withstand at least four one-minute submersions in a copper sulfate solution having a specific gravity of about 1.186 at a temperature of from about 63° F. to about 67° F.

37. The system of claim 36, further comprising a temperature adjuster

38. The system of claim 36, further comprising a second spray metallizer, capable of spraying a molten metal onto the weld seam.

39. The system of claim 38, wherein the molten metal is zinc, aluminum, tin, or an alloy of zinc and aluminum, zinc and tin, or tin and aluminum.

40. The system of claim 36, wherein the first spray metallizer is an electric arc spray gun.

41. The system of claim 36, wherein the tube former is a tube mill.

42. The system of claim 36, wherein the welder is a continuous welder.

43. The system of claim 42, wherein the continuous welder is an electric resistance welder, a TIG welder, or a laser welder.
